(19) United States
(12) Patent Application Publication
(10) Pub. No.: US 2010/0091059 A1
(43) Pub. Date: Apr. 15, 2010

(54) LIQUID JET APPARATUS AND PRINTING APPARATUS

(75) Inventors: Atsushi OSHIMA, Shiojiri-shi (JP); Kunio TABATA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/637,412

(22) Filed: Dec. 14, 2009

Related U.S. Application Data
(62) Division of application No. 11/923,448, filed on Oct. 24, 2007.

(30) Foreign Application Priority Data
Oct. 25, 2006 (JP) 2006-290325
Oct. 12, 2007 (JP) 2007-266241

(51) Int. Cl. B41J 2/07

(52) U.S. Cl. 347/10

(57) ABSTRACT

A liquid jet apparatus according to the present invention includes a plurality of nozzles, an actuator provided for each nozzle and connected to the respective nozzle, and a drive unit for applying a drive signal to the actuator. The drive unit includes a drive waveform generator that generates a drive waveform signal for controlling the drive of the actuator, a modulator for performing a pulse modulation of the drive waveform signal to produce a modulated signal, a digital power amplifier for power amplifying the modulated signal to produce an amplified signal, a low-pass filter for smoothing the amplified signal and supplying the drive signal to the actuator, and a modulation signal correcting unit that corrects the modulated signal according to a power supply voltage of the digital power amplifier.

### CROSS-REFERENCE TO A RELATED APPLICATION

This application is a Divisional of U.S. patent application Ser. No. 11/923,448 filed Oct. 24, 2007 which claimed priority to Japanese Patent Application Number 2006-290325 filed Oct. 25, 2006 and to Japanese Patent Application Number 2007-266241 filed Oct. 12, 2007. The entire disclosures of these applications are expressly incorporated herein by reference.

### BACKGROUND

1. Technical Field

The present invention relates to a liquid jet apparatus and printing apparatus arranged to print predetermined letters and images by emitting microscopic droplets of liquids from a plurality of nozzles to form the microscopic particles (dots) thereof on a printing medium.

2. Related Art

An inkjet printer as one of such printing apparatuses, which is generally low-price and easily provides high quality color prints, has widely used not only in offices but also for general users often in conjunction with the widespread use of personal computers and digital cameras. In recent inkjet printers, printing in fine tone is required. Tone denotes a state of density of each color included in a pixel expressed by a liquid dot, the size of the dot corresponding to the color density of each pixel is called a tone grade, and the number of tone grades capable of being expressed by a liquid dot is called a tone number. Fine tone denotes that the tone number is large. In order to change the tone grade, it is required to modify a drive pulse to an actuator provided in a liquid jet head. When a piezoelectric element is used as the actuator the tone grade of the liquid dot can be changed very accurately because the amount of displacement of the piezoelectric element (distortion of a diaphragm, to be precise) becomes large when the voltage value applied to the piezoelectric element becomes large.

Therefore, in JP-A-10-81013, a plurality of drive pulses with different wave heights are combined and joined, the drive pulses are commonly output to the piezoelectric elements of the nozzles of the same color provided to the liquid jet head, a drive pulse corresponding to the tone grade of the liquid dot to be formed is selected for every nozzle out of the plurality of drive pulses, and the selected drive pulses are supplied to the piezoelectric elements of the corresponding nozzles to emit droplets of the liquid in different amounts, thereby achieving the required tone grade of the liquid dot.

The method of generating the drive signals (or the drive pulses) is described in FIG. 2 of JP-A-2004-306434. Specifically, the data is retrieved from a memory storing the data of the drive signal, the data is converted into analog data by a D/A converter, and the drive signal is supplied to the liquid jet head through a voltage amplifier and a current amplifier. The circuit configuration of the current amplifier is, as shown in FIG. 3 of JP-A-2004-306434, composed of push-pull connected transistors, and the drive signal is amplified by a so called linear drive. However, in the current amplifier with such a configuration, the linear drive of the transistor is inefficient. A large-sized transistor is required as a measure against heating of the transistor. Moreover, a heat radiation plate for cooling the transistor is required. Thus, a disadvantage of growth in the circuit size arises, and among others, the size of the heat radiation plate constitutes a great barrier to layout design.

To overcome this disadvantage, a digital power amplifier, i.e., a class D amplifier can be used for amplified output of the drive signal. The digital power amplifier has better power amplification efficiency than an analog power amplifier, has little power loss, and can cope with high-speed rising or falling of the drive signal. However, when the drive signal is amplified using a digital power amplifier, the voltage value of the output drive signal changes with a change of the power supply voltage. In the ink-jet printer described in JP-A-2005-329710, correction is performed by returning the output drive signal, i.e., by applying feedback.

In the method of feeding back the drive signal, however, parts, such as a D/A converter to generate an analog signal to be compared with the fed back drive signal, and a feedback circuit are required which increases the number of parts and the cost. Since the drive signal generated by a pulse modulator, a digital power amplifier and a low-pass filter is fed back, the correction cannot follow the rapid change of the power supply voltage. In addition, since the phase of the drive signal changes according to the number of actuators to be driven, a filter with a single phase characteristic cannot cope with the phase change of the drive signal to be fed back.

### BRIEF SUMMARY OF THE INVENTION

An object of the invention is to provide a liquid jet apparatus and printing apparatus capable of reducing and preventing the change of voltage in the drive signal due to the change of power supply voltage while reducing and preventing an increase in the number of parts and an increase in the cost.

A liquid jet apparatus according to the present invention includes: a plurality of nozzles, an actuator provided for each nozzle and connected to the respective nozzle, and a drive unit for applying a drive signal to the actuator. The drive unit includes a drive waveform generator that generates a drive waveform signal for controlling the drive of the actuator, a modulator for performing a pulse modulation of the drive waveform signal to produce a modulated signal, a digital power amplifier for power amplifying the modulated signal to produce an amplified signal, a low-pass filter for smoothing the amplified signal and supplying the drive signal to the actuator, and a modulation signal correcting unit that corrects the modulated signal according to a power supply voltage of the digital power amplifier.

According to the liquid jet apparatus as described above, the filter characteristics of the low-pass filter are capable of sufficiently smoothing the amplified signal. Thereby, high-speed rise and fall of the drive signal can be achieved. Additionally, since the drive signal can be subject to power amplification efficiently by the digital power amplifier with little power loss, a cooling unit, such as cooling radiator plate, is not required.

In addition, since the modulated signal is corrected according to the power supply voltage of the digital power amplifier, the change in voltage in the drive signal due to the change in the power supply voltage to the digital power amplifier can be reduced and eliminated while reducing and eliminating an increase in the number of parts and in the cost.

It is desirable that the modulation signal correcting unit includes a power supply voltage detecting unit that detects the power supply voltage of the digital power amplifier, and a drive waveform signal correcting unit that corrects the drive waveform signal based on the power supply voltage detected in the power supply voltage detecting unit.

In addition, it is desirable that the modulated signal correcting unit includes a power supply voltage detecting unit that detects the power supply voltage of the digital power amplifier and a triangular wave signal correcting unit that corrects an oscillation of triangular wave signal used for the pulse modulation based on the power supply voltage detected in the power supply voltage detecting unit.

According to the liquid jet apparatus as described above, the change of the voltage in the drive signal due to the change of the power supply voltage to the digital power amplifier can be reliably reduced and prevented.

Further, it is desirable that the modulation signal correcting unit includes a variable power supply voltage calculating unit that calculates variable power supply voltage of the digital power amplifier based on the number of actuators to be driven, and a drive waveform signal correcting unit that corrects the drive waveform signal based on the variable power supply voltage calculated in the variable power supply voltage calculating unit.

In addition, it is desirable that the modulation signal correcting unit includes a variable power supply voltage calculating unit that calculates variable power supply voltage of the digital power amplifier based on the number of actuators to be driven, and a triangular wave signal correcting unit that corrects an oscillation of the triangular wave signal used for pulse modulation based on the variable power supply voltage calculated in the variable power supply voltage calculating unit.

According to the liquid jet apparatus as described above, the change of the voltage in the drive signal due to the rapid change of the power supply voltage to the digital power amplifier can be reliably reduced and prevented.

In addition, it is desirable that a printing apparatus according to the invention is a printing apparatus including the aforementioned liquid jet apparatus.

According to the printing apparatus in the invention as described above, the filter characteristics of the low-pass filter are capable of sufficiently smoothing the amplified signal, and thereby high-speed rise and fall of the drive signal can be achieved. Additionally, since the drive signal can be subject to efficient power amplification by the digital power amplifier with little power loss, a cooling unit, such as cooling radiator plate, is not required and power loss can be reduced as a result. Therefore, a plurality of liquid jet heads can be efficiently arranged and the printing apparatus can be smaller in size.

In addition, the change of the voltage in the drive signal due to the change of the power supply voltage to the digital power amplifier can be reduced and prevented while reducing and preventing an increase of the number of parts and the cost because the modulation signal is corrected according to the power supply voltage to the digital power amplifier.

### BRIEF DESCRIPTION OF THE DRAWINGS

FIG. 1 shows a top view of an overall configuration showing an embodiment of a line head printing apparatus applying the liquid jet apparatus according to the present invention;

FIG. 1B is a front view of the line head ink jet printer of FIG. 1A;

FIG. 2 is a block diagram of a controlling apparatus of the printing apparatus in FIG. 1;

FIG. 3 is a block diagram of a drive waveform generator in FIG. 2;

FIG. 4 is an explanatory diagram of a waveform memory in FIG. 3;

FIG. 5 is an explanatory diagram of a drive waveform signal generation;

FIG. 6 is an explanatory diagram of the drive waveform signal or a drive signal with time-series connection;

FIG. 7 is a block diagram of a drive signal output circuit;

FIG. 8 is a block diagram of a selecting section connecting the drive signal to an actuator;

FIG. 9 is a block diagram showing the details of a modulator, a digital power amplifier and a low-pass filter of the drive signal output circuit in FIG. 7;

FIG. 10 is an explanatory diagram of an operation of the modulator in FIG. 9;

FIG. 11 is an explanatory diagram of an operation of the digital power amplifier in FIG. 9;

FIG. 12 is an explanatory diagram of a change of voltage in the drive signal due to a change of power supply voltage;

FIG. 13 is a block diagram showing the modulator in a first embodiment;

FIGS. 14A and 14B are explanatory diagrams of a drive waveform signal, a triangular wave signal and a modulation signal from the modulator in FIG. 13;

FIG. 15 is a block diagram showing the modulator in a second embodiment;

FIGS. 16A and 16B are explanatory diagrams of a drive waveform signal, a triangular wave signal and a modulation signal from the modulator in FIG. 15;

FIG. 17 is a block diagram showing the modulator in a third embodiment;

FIG. 18 is an explanatory diagram of a variable power supply voltage due to a change in the number of driving actuators;

FIG. 19 is a flowchart showing an example of an arithmetic process performed in an arithmetic circuit; and

FIG. 20 is a block diagram showing the modulator in a fourth embodiment.

### DETAILED DESCRIPTION OF THE PREFERRED EMBODIMENTS

An embodiment will be explained with reference to the drawings, using a printing apparatus for printing letters and images on a print medium by emitting a liquid, as an example of the present invention.

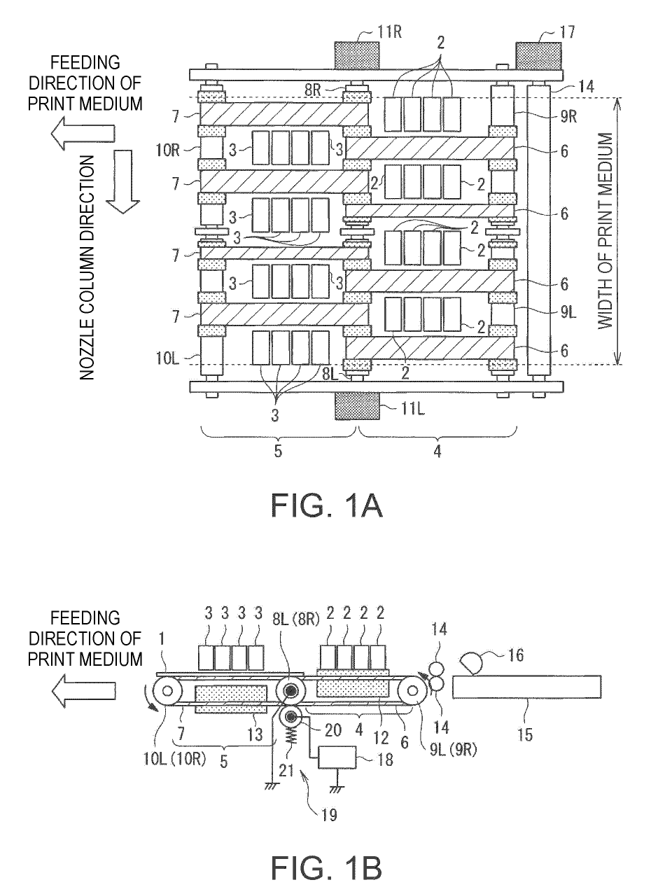

FIGS. 1A and 1B are schematic configuration views of the printing apparatus according to the present embodiment, wherein FIG. 1A is a top plain view thereof, and FIG. 1B is a front view thereof. In FIG. 1, in the line head printing apparatus, a print medium 1 is conveyed from the upper right to the lower left of the drawing along the arrow direction, and printing occurs in a print area in the middle of the conveying path. It should be noted that the liquid jet heads of the present embodiment are not arranged in one line, but are arranged in two lines.

A first line of liquid jet heads 2 are arranged on the “upstream” side in the direction of conveyance of the print medium 1. A second line of liquid jet heads 3 are arranged on the downstream side. A first conveying section 4 for conveying the print medium 1 is disposed below the first liquid jet head 2, and a second conveying section 5 is disposed below the second liquid jet head 3. The first conveying section 4 is composed of four first conveying belts 6 disposed with predetermined intervals in the direction (hereinafter also referred to as a nozzle array direction) traversing the conveying direction of the print medium 1, the second conveying section 5 is similarly composed of four second conveying belts 7 disposed with predetermined intervals in the nozzle array direction.

The four first conveying belts 6 and the similar four second conveying belts 7 are alternated with respect to each other. In the present embodiment, out of the conveying belts 6 and 7, the two first and second conveying belts 6 and 7 in the right side in the nozzle array direction are distinguished from the two first and second conveying belts 6 and 7 in the left side in the nozzle array direction. In other words, an overlapping portion of two of the first and second conveying belts 6 and 7 in the right side in the nozzle array direction is provided with a right side drive roller 8R, an overlapping portion of two of the first and second conveying belts 6 and 7 in the left side in the nozzle array direction is provided with a left side drive roller 8L, a right side first driven roller 9R and left side first driven roller 9L are disposed on the upstream side thereof, and a right side second driven roller 10R and left side second driven roller 10L are disposed on the downstream side thereof. Although these rollers may appear to be single rollers, they are actually decoupled in the center portion of FIG. 1A.

Further, the two first conveying belts 6 in the right side in the nozzle array direction are wound around the right side drive roller 8R and the right side first driven roller 9R. The two first conveying belts 6 in the left side in the nozzle array direction are wound around the left side drive roller 8L and the left side first driven roller 9L. The two second conveying belts 7 in the right side in the nozzle array direction are wound around the right side drive roller 8R and the right side second driven roller 10R. The two second conveying belts 7 in the left side in the nozzle array direction are wound around the left side drive roller 8L and the left side second driven roller 10L.

Further, a right side electric motor 11R is connected to the right side drive roller 8R, and a left side electric motor 11L is connected to the left side drive roller 8L. Therefore, when the right side electric motor 11R drives the right side drive roller 8R, the first conveying section 4 composed of the two first conveying belts 6 in the right side in the nozzle array direction and similarly the second conveying section 5 composed of the two second conveying belts 7 in the right side in the nozzle array direction move in sync with each other and at the same speed when the left side electric motor 11L drives the left side drive roller 8L, the first conveying section 4 composed of the two first conveying belts 6 in the left side in the nozzle array direction and similarly the second conveying section 5 composed of the two second conveying belts 7 in the left side in the nozzle array direction move in sync with each other and at the same speed.

It should be noted that by arranging the rotational speeds of the right side electric motor 11R and the left side electric motor 11L to be different from each other, the conveying speeds in the left and right in the nozzle direction can be different from each other. Specifically, by arranging the rotational speed of the right side electric motor 11R higher than the rotational speed of the left side electric motor 11L, the conveying speed in the right side in the nozzle array direction can be made higher than that in the left side. By arranging the rotational speed of the left side electric motor 11L higher than the rotational speed of the right side electric motor 11R, the conveying speed in the left side in the nozzle array direction can be made higher than that in the right side.

The first liquid jet heads 2 and the second liquid jet heads 3 include a set of colors, yellow (Y), magenta (M), cyan (C), and black (K) shifted in the conveying direction of the print medium 1. The liquid jet heads 2 and 3 are supplied with liquids from liquid tanks (not shown) of their respective colors via liquid supply tubes (not shown). Each of the liquid jet heads 2 and 3 is provided with a plurality of nozzles formed in the nozzle array direction and by emitting the necessary amount of liquid jet from the respective nozzles simultaneously to the necessary positions, microscopic liquid dots are formed on the print medium 1. By performing the process described above by the set of colors, one-pass print can be achieved by making the print medium 1 conveyed by the first and second conveying sections 4 and 5 pass therethrough once. In other words, the area in which the liquid jet heads 2 and 3 are disposed corresponds to the print area.

A method of emitting liquid jets from each of the nozzles of the liquid jet heads can include an electrostatic method, a piezoelectric method, a film boiling jet method, and so on. In the electrostatic method, when a drive signal is provided to an electrostatic gap as an actuator, a diaphragm in the cavity is displaced to cause pressure variation in the cavity, and the liquid is emitted from the nozzle in accordance with the pressure variation. In the piezoelectric method, when a drive signal is provided to a piezoelectric element as an actuator, a diaphragm in the cavity is displaced to cause pressure variation in the cavity, and the liquid is emitted from the nozzle in accordance with the pressure variation. In the film boiling jet method, a microscopic heater is provided in the cavity, and is instantaneously heated to be at a temperature higher than 300° C. to make the liquid enter the boiling state to generate a bubble, thus causing a pressure variation and making the liquid be emitted from the nozzle. The present invention can apply to any of the above liquid jet methods, and others. However, the invention is particularly suitable for the piezoelectric element, capable of adjusting an amount of the liquid jet by controlling the wave height and/or gradient of the increase or decrease in the voltage in the drive signal.

The liquid jet nozzles of the first liquid jet heads 2 are provided between the four first conveying belts 6 of the first conveying section 4, and the liquid jet nozzles of the second liquid jet heads 3 are provided between the four second conveying belts 7 of the second conveying section 5. Although this is for cleaning each of the liquid jet heads 2 and 3 with a cleaning section described below, the entire surface is not printed by one-pass printing if either one of the liquid jet heads is used independently. Therefore, the first liquid jet heads 2 and the second liquid jet heads 3 are disposed alternately in the conveying direction of the print head 1 in order to compensate for each other's unprintable areas.

Disposed below the first liquid jet heads 2 is a first cleaning cap 12 for cleaning the first liquid jet heads 2, and disposed below the second liquid jet heads 3 is a second cleaning cap 13 for cleaning the second liquid jet head 3. Each of the cleaning caps 12 and 13 is formed to allow the cleaning caps to pass between the four first conveying belts 6 of the first conveying section 4 and between the four second conveying belts 7 of the second conveying section 5. Each of the cleaning caps 12 and 13 is composed of a cap body having a rectangular shape with a top, covering the nozzles provided on the lower surface, namely the nozzle surface of the liquid jet heads 2 and 3, and capable of adhering to the nozzle surface, a liquid absorbing body disposed at the bottom of the cap body, a peristaltic pump connected to the bottom of the cap body, and an elevating device for moving the cap body up and down. The cap body is moved up by the elevating device to be adhered to the nozzle surface of the liquid jet heads 2 and 3. By causing negative pressure in the cap body using the peristaltic pump in the present state, the liquid and bubbles are suctioned from the nozzle openings on the nozzle surface of the liquid jet heads 2 and 3, thus the cleaning of the liquid jet heads 2 and 3 can be performed. After the cleaning is completed, each of the cleaning caps 12 and 13 is moved down.

On the upstream side of the first driven rollers 9R and 9L, there are provided a pair of gate rollers 14 for adjusting the feed timing of the print medium 1 from a feeder section 15 and at the same time correcting the skew of the print medium 1. The skew denotes a rotation of the print medium 1 with respect to the conveying direction. Further, above the feeder section 15, there is provided a pickup roller 16 for feeding the print medium 1. A gate roller motor 17 drives the gate rollers 14.

A belt charging device 19 is disposed below the drive rollers 8R and 8L. The belt charging device 19 is composed of a charging roller 20 having a contact with the first conveying belts 6 and the second conveying belts 7 via the drive rollers 8R and 8L, a spring 21 for pressing the charging roller 20 against the first conveying belts 6 and the second conveying belts 7, and a power supply 18 for providing charge to the charging roller 20. The belt charging device 19 charges the first conveying belts 6 and the second conveying belts 7 by providing them with the charge from the charging roller 20. Since the belts are generally made of a moderate or high resistivity material or an insulating material, when the they are charged by the belt charging device 19, the charge applied on the surface thereof causes the print medium 1, made similarly of a high resistivity material or an insulating material, to achieve dielectric polarization, and the print medium 1 can be adhered to the belt by the electrostatic force caused between the charge generated by the dielectric polarization and the charge on the surface of the belt. It should be noted that as the belt charging device 19, a corotron for showering charge can also be used.

Therefore, according to the present printing apparatus, when the surfaces of the first conveying belts 6 and the second conveying belts 7 are charged by the belt charging device 19, the print medium 1 is fed from the gate roller 14, and the print medium 1 is pressed against the first conveying belts 6 by a sheet pressing roller composed of a spur or a roller (not shown), the print medium 1 is adhered to the surfaces of the first conveying belts 6 under the action of dielectric polarization. When the electric motors 11R and 11L drive the drive rollers 8R and 8L, the drive force is transmitted to the first driven rollers 9R and 9L via the first conveying belts 6.

Thus, the first conveying belts 6 are moved to the downstream side of the conveying direction while adhering to the print medium 1, printing is performed by emitting liquid from the nozzles formed on the first liquid jet heads 2 while moving the print medium 1 below the first liquid jet heads 2. When the printing by the first liquid jet heads 2 is complete, the print medium 1 is moved to the downstream side of the conveying direction to be switched to the second conveying belts 7 of the second conveying section 5. As described above, since the second conveying belts 7 are also provided with the charge on the surface thereof by the belt charging device 19, the print medium 1 is adhered to the surfaces of the second conveying belts 7 under the action of the dielectric polarization.

The second conveying belts 7 are moved to the downstream side of the conveying direction, printing is performed by emitting liquid from the nozzles formed on the second liquid jet heads 3 while moving the print medium 1 below the second liquid jet heads 3. After printing by the second liquid jet heads 3 is complete, the print medium 1 is moved further to the downstream side of the conveying direction, the print medium 1 is ejected to a catch tray while separating it from the surfaces of the second conveying belts 7 by a separating device (not shown).

When cleaning of the first and second liquid ejection heads 2 and 3 becomes necessary, as described above, the first and second cleaning caps 12 and 13 are raised to be adhered to the nozzle surfaces of the first and second liquid jet heads 2 and 3, the cleaning is performed by applying negative pressure to the inside of the caps to suction ink droplets and bubbles from the nozzles of the first and second liquid jet heads 2 and 3, and then, the first and second cleaning caps 12 and 13 are moved down.

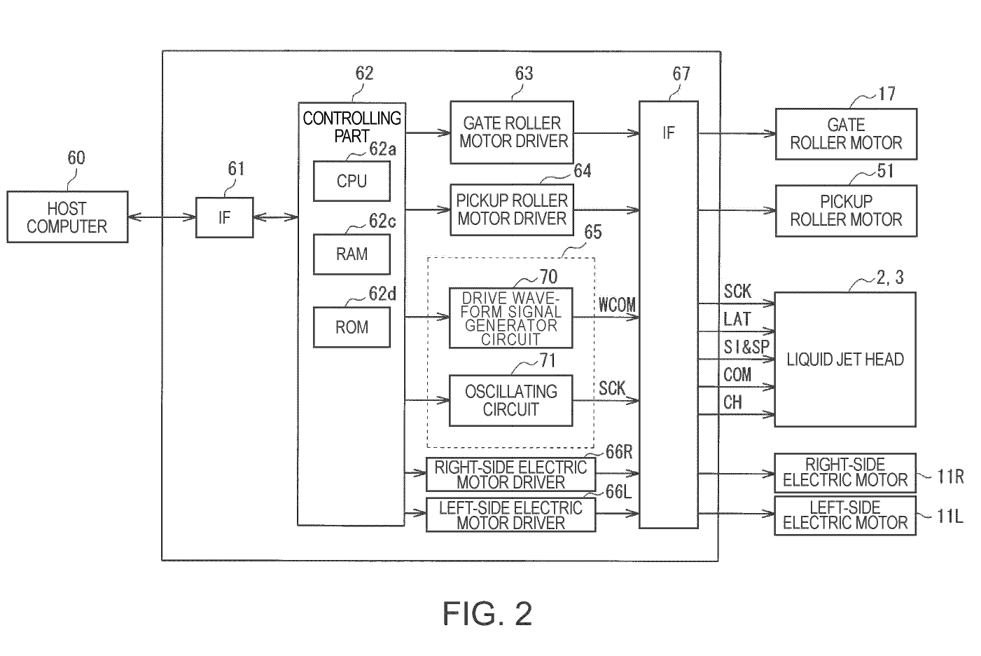

Inside the printing apparatus, there is provided a control device for controlling the apparatus itself. The control device is, as shown in FIG. 2, for controlling the printing apparatus, the feeder device, and so on, based on print data input from a host computer 60, such as a personal computer or a digital camera, thereby performing the print process on the print medium 1. Further, the control device includes an input interface section 61 for receiving print data input from the host computer 60, a control section 62 formed of a microcomputer for performing the print process based on the print data input from the input interface section 61, a gate roller motor driver 63 for driving the gate roller motor 17, a pickup roller motor driver 64 for driving a pickup roller motor 51 for driving the pickup roller 16, a head driver 65 for driving the liquid jet heads 2 and 3, a right side electric motor driver 66R for driving the right side electric motor 11R, a left side electric motor driver 66L for driving the left side electric motor 11L, and an interface 67 for converting the output signals of the drivers 63, 64, 65, 66R, and 66L into drive signals used in the gate roller motor 17, the pickup roller motor 51, the liquid jet heads 2 and 3, the right side electric motor 11R, and the left side electric motor 11L.

The control section 62 is provided with a central processing unit (CPU) 62a for performing various processes, such as the print process, a random access memory (RAM) 62c for temporarily storing the print data input via the input interface 61 and various kinds of data used in performing the print process of the print data, and for temporarily developing an application program, such as for the print process, and a read-only memory (ROM) 62d formed of a nonvolatile semiconductor memory and for storing the control program executed by the CPU 62a and so on. When the control section 62 receives the print data (image data) from the host computer 60 via the interface section 61, the CPU 62a performs a predetermined process on the print data to output printing data (drive pulse selection data SI & SP) regarding which nozzle emits the liquid and/or how much liquid is emitted, and further outputs the control signals to the respective drivers 63, 64, 65, 66R, and 66L based on the printing data and the input data from the various sensors. When the control signals are output from the respective drivers 63, 64, 65, 66R, and 66L, the control signals are converted by the interface section 67 into the drive signals, the actuators corresponding to a plurality of nozzles of the liquid jet heads 2 and 3, the gate roller motor 17, the pickup roller motor 51, the right side electric motor 11R, and the left side electric motor 11L respectively operate, thus the feeding and conveying the print medium 1, posture control of the print medium 1, and the print process to the print medium 1 are performed. It should be noted that the elements inside the control section 62 are electrically connected to each other via a bus (not shown).

In order to write the waveform forming data DATA for forming the drive signal described later in a waveform memory 701, the control section 62 outputs a write enable signal DEN, a write clock signal WCLK, and write address data A0 through A3 to write the 16 bit waveform forming data DATA into the waveform memory 701, and further, outputs the read address data A0 through A3 for reading the waveform forming data DATA stored in the waveform memory 701, a first clock signal ACLK for setting the timing for latching the waveform forming data DATA retrieved from the waveform memory 701, a second clock signal BCLK for setting the timing for adding the latched waveform data, and a clear signal CLER for clearing the latched data to the head driver 65.

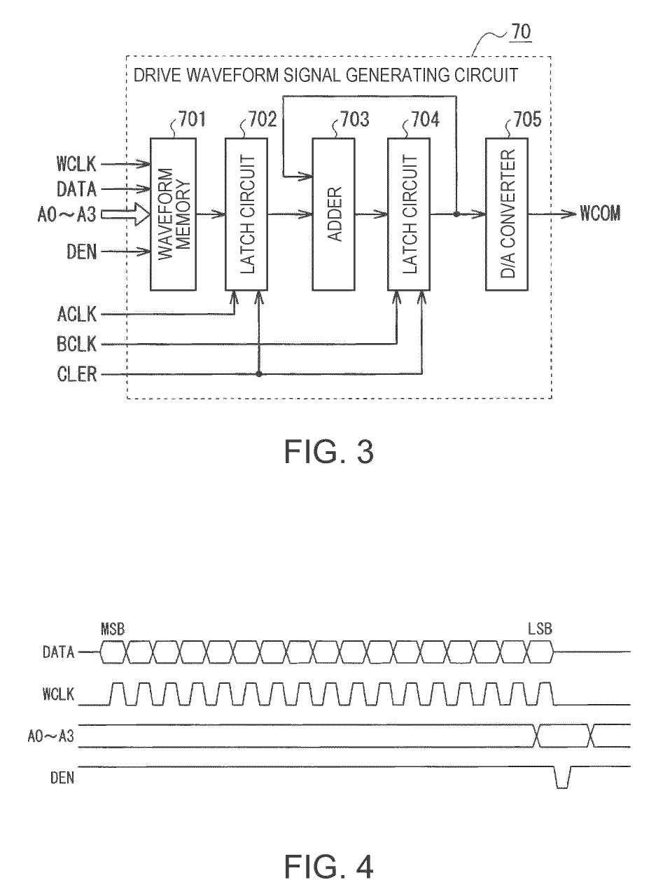

The head driver 65 is provided with a drive waveform generator 70 for forming the drive waveform signal WCOM and an oscillator circuit 71 for outputting a clock signal SCK. The drive waveform generator 70 is provided, as shown in FIG. 3, with waveform memory 701 for storing the waveform forming data DATA input from the control section 62 in the storage element corresponding to a predetermined address, a latch circuit 702 for latching the waveform forming data DATA retrieved from the waveform memory 701 in accordance with the first clock signal ACLK described above, an adder 703 for adding the output of the latch circuit 702 with the waveform generation data WDATA output from a latch circuit 704 described later, the latch circuit 704 for latching the added output of the adder 703 in accordance with the second clock signal BCLK, and a D/A converter 705 for converting the waveform generation data WDATA output from the latch circuit 704 into an analog signal. The clear signal CLER output from the control section 62 is input to the latch circuits 702 and 704, and when the clear signal CLER is in the off state, the latched data is cleared.

The waveform memory 701 is provided, as shown in FIG. 4, with several bits of memory elements arranged in each designated address, and the waveform data DATA is stored together with the address A0 through A3. Specifically, the waveform data DATA is input in accordance with the clock signal WCLK with respect to the address A0 through A3 designated by the control section 62, and the waveform data DATA is stored in the memory elements in response to input of the write enable signal DEN.

The principle of generating the drive waveform signal by the drive waveform generator 70 will now be explained. First, in the address A0, there is written the waveform data of zero as an amount of voltage variation per unit time period. Similarly, the waveform data of +ΔV1 is written in the address A1, the waveform data of −ΔV2 is written in the address A2, and the waveform data of +ΔV3 is written in the address A3. Further, the stored data in the latch circuits 702 and 704 is cleared by the clear signal CLER. Further, the drive waveform signal WCOM is raised to an intermediate voltage potential (offset) by the waveform data.

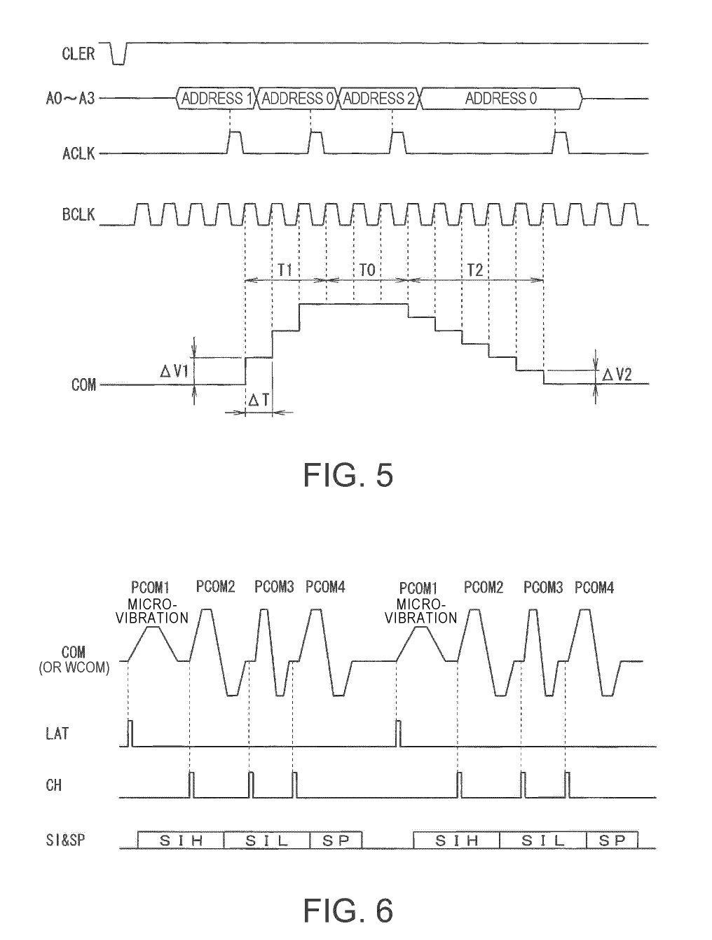

When the waveform data in the address A1 is retrieved, as shown in FIG. 5, for example, and the first clock signal ACLK is input, the digital data of +ΔV1 is stored in the latch circuit 702. The stored digital data of +ΔV1 is input to the latch circuit 704 via the adder 703, and in the latch circuit 704, the output of the adder 703 is stored in sync with the rising of the second clock signal BCLK. Since the output of the latch circuit 704 is also input to the adder 703, the output of the latch circuit 704, namely the drive signal COM is added with +ΔV1 with every rising of the second clock signal BCLK. In the present example, the waveform data in the address of A1 is retrieved for a time interval of T1, and as a result, the digital data of +ΔV1 is tripled.

Subsequently, when the waveform data in the address A0 is retrieved, and in addition, the first clock signal ACLK is input, the digital data stored in the latch circuit 702 is switched to zero. Although this digital data of zero is, similarly to the case described above, added through the adder 703 with the rising timing of the second clock signal BCLK, since the digital data is zero, the previous value is maintained. In the present example, the drive signal COM is maintained at a constant value for the time period of T0.

Subsequently, when the waveform data in the address A2 is retrieved, and in addition, the first clock signal ACLK is input, the digital data stored in the latch circuit 702 is switched to −ΔV2. Although the digital data of −ΔV2 is, similarly to the case described above, added through the adder 703 on the rising edge of the second clock signal BCLK, since the digital data is −ΔV2, the drive signal COM is actually subtracted by −ΔV2 in accordance with the second clock signal. In the present embodiment, the digital data is subtracted for the time period of T2 until the digital data becomes six times as large as −ΔV2.

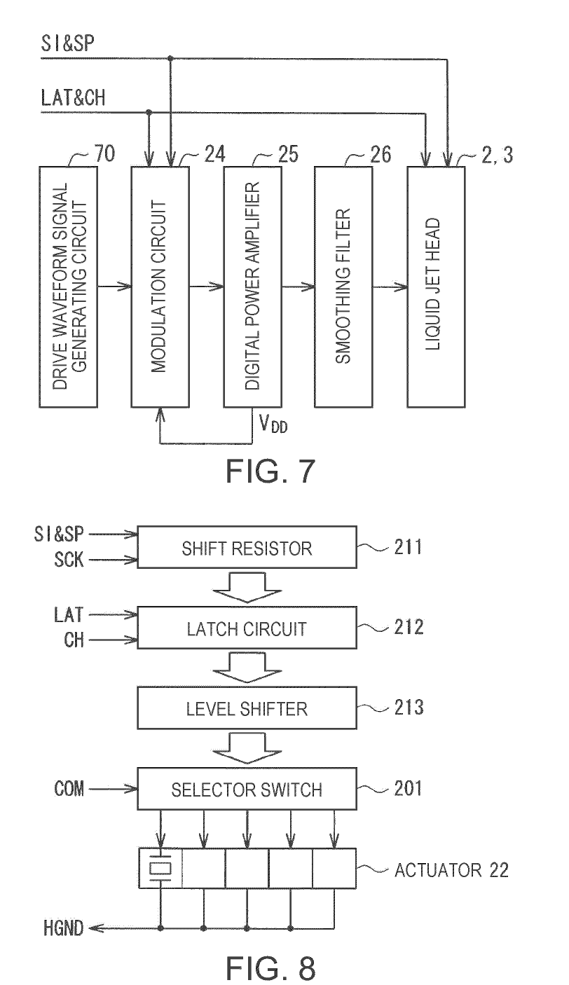

By performing the analog conversion by the D/A converter 705 on the digital signal thus generated, the drive waveform signal WCOM as shown in FIG. 6 can be obtained. By performing the power amplification by the drive signal output circuit shown in FIG. 7 on the above signal, and supplying it to the liquid jet heads 2 and 3 as the drive signal COM, it becomes possible to drive the actuator provided at each of the nozzles, thus the liquid can be emitted from each of the nozzles. The drive signal output circuit includes a modulator 24 for performing the pulse width modulation on the drive waveform signal WCOM generated by the drive waveform generator 70, a digital power amplifier 25 for performing the power amplification on the modulated (PWM) signal, and a low-pass filter 26 for smoothing the amplified signal.

The rising portion of the drive signal COM corresponds to the stage of expanding the capacity of the cavity (pressure chamber) communicating the nozzle to pull in the liquid (it can be said that the meniscus is pulled in considering the emission surface of the liquid), and the falling portion of the drive signal COM corresponding to the stage of reducing the capacity of the cavity to push out the liquid (it can be said that the meniscus is pushed out considering the emission surface of the liquid), as the result of pushing out the liquid, the liquid is emitted from the nozzle. The series of waveform signals from pulling in the liquid to pushing out the liquid according to the print dot form the drive pulse, and the drive signal COM is formed by linking a plurality of drive pulses. The waveform of the drive signal COM or of the drive waveform signal WCOM can be, as easily inferred from the above description, adjusted by the waveform data 0, +ΔV1, −ΔV2, and +ΔV3 stored in the addresses A0 through A3, the first clock signal ACLK and the second clock signal BCLK. Further, although the first clock signal ACLK is called a clock signal for the sake of convenience, actually, an arithmetic process described later can freely adjust the output timing of the signal.

A single drive signal COM formed of this trapezoidal voltage wave is assumed to be the drive pulse PCOM, and by variously changing the slope of the increase and the decrease in the voltage and the height of the wave of the drive pulse PCOM, the pull-in amount and the pull-in speed of the liquid, and the push-out amount and the push-out speed of the liquid can be changed, therefore, the amount of liquid jet emission can be changed to obtain a different size of the liquid dot. Therefore, as shown in FIG. 6, when a plurality of drive pulses PCOM are sequentially joined to form the drive signal COM, it is possible that the single drive pulse PCOM is selected from such drive pulses to supply the actuator to emit the liquid jet, or a plurality of drive pulses PCOM are selected and supplied to the actuator to emit the liquid jet a plurality of times, thus liquid dots with various sizes can be obtained. In other words, when a number of liquid droplets land on the same position while the liquid is not yet dry, it creates substantially the same result as emitting a larger droplet of the liquid, thus the size of the liquid dot can be enlarged. By combination of such technologies fine tone printing can be achieved. It should be noted that the drive pulse PCOM 1 shown in the left end of FIG. 6 is only for pulling in the liquid without pushing out the liquid. This is called a fine vibration, and is used for preventing the nozzle from drying when not emitting the liquid jet.

As a result of the above, the liquid jet heads 2 and 3 are provided with the drive signal COM generated by the drive signal output circuit, the drive pulse selection data SI & SP for selecting the nozzle emitting the liquid jet and determining the connection timing of the actuator to the drive signal COM based on the print data, the latch signal LAT and a channel signal CH for connecting the drive signal COM and the actuator of the liquid jet heads 2 and 3 based on the drive pulse selection data SI & SP after the nozzle selection data is input to all of the nozzles, and the clock signal SCK for transmitting the drive pulse selection data SI & SP to the liquid jet heads 2 and 3 as a serial signal input thereto. It should be noted that hereinafter, when a plurality of drive signals COM are joined and output in a time-series manner, a single drive signal COM is described as the drive pulse PCOM, and the whole signal obtained by joining the drive pulse PCOM in a time-series manner is described as the drive signal COM.

The configuration of connecting the drive signals COM output from the drive signal output circuit to the actuator will now be explained. FIG. 8 is a block diagram of the selection section for connecting the drive signals COM to the actuators 22, such as a piezoelectric element. The selection section is composed of a shift register 211 for storing the drive pulse selection data SI & SP for designating the actuator 22, such as a piezoelectric element, corresponding to the nozzle from which the liquid jet is to be emitted, a latch circuit 212 for temporarily storing the data of the shift register 211, a level shifter 213 for performing level conversion on the output of the latch circuit 212, and a selection switch 201 for connecting the drive signal COM to the actuator 22, such as a piezoelectric element, in accordance with the output of the level shifter.

The drive pulse selection data SI & SP is sequentially input to the shift register 211, and at the same time, the storage area is sequentially shifted from the first stage to the subsequent stage in accordance with the input pulse of the clock signal SCK. The latch circuit 212 latches the output signals of the shift register 211 in accordance with the input latch signal LAT after the drive pulse selection data SI & SP corresponding to the number of the nozzles is stored in the shift register 211. The signals stored in the latch circuit 212 are converted into a voltage level capable of switching on and off the selection switch 201 on the subsequent stage by the level shifter 213. This is because the drive signal COM has a high voltage compared to the output voltage of the latch circuit 212, and the operating voltage range of the selection switch 201 is also set higher accordingly. Therefore, the actuator 22, such as piezoelectric element, the selection switch 201 of which is closed by the level shifter 213 is connected to the drive signal COM with the connection timing of the drive pulse selection data SI & SP. After the drive pulse selection data SI & SP of the shift register 211 is stored in the latch circuit 212, the subsequent drive pulse selection data SI & SP is input to the shift register 211, and the stored data of the latch circuit 212 is sequentially updated with the liquid jet emission timing. It should be noted that the reference HGND in the drawings denotes the ground terminal for the actuator 22, such as the piezoelectric element. Further, according to the selection switch 201, even after the actuator 22, such as the piezoelectric element, is separated from the drive signal COM, the input voltage of the actuator 22 is maintained at the voltage immediately before separation.

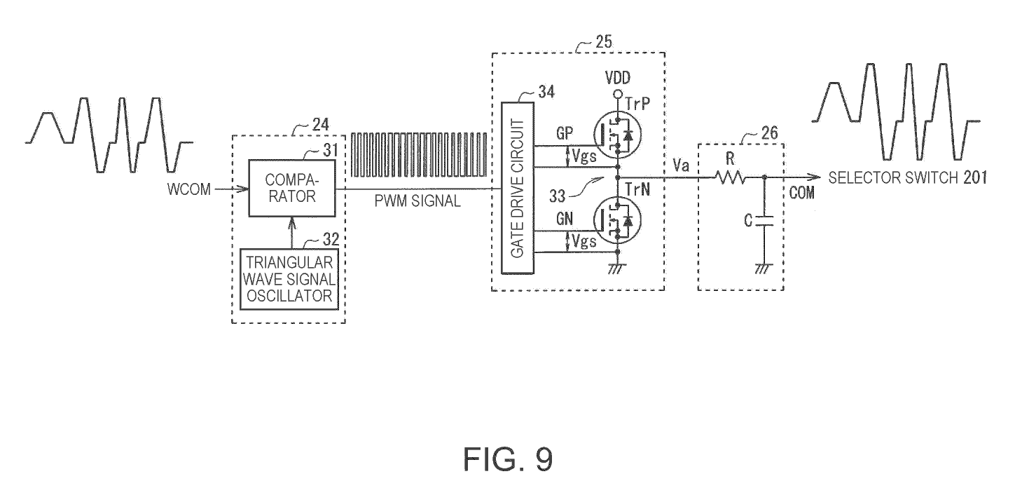

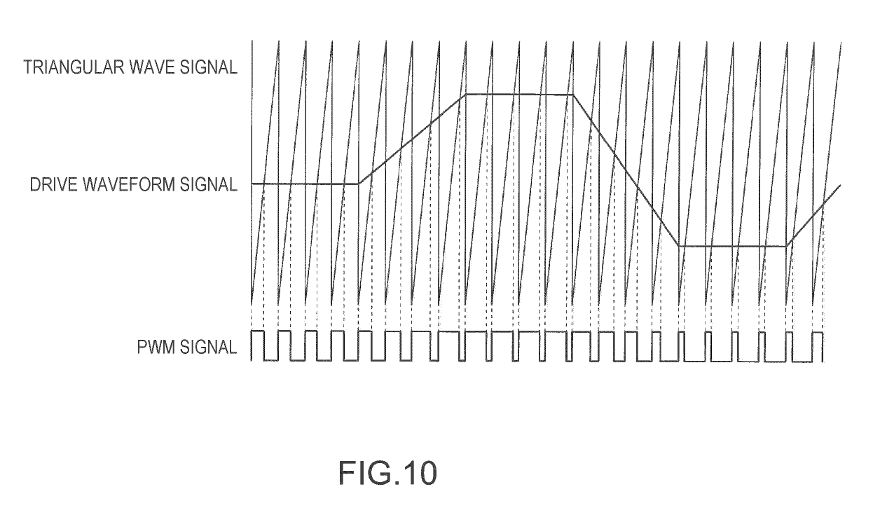

FIG. 9 shows a specific configuration of the modulator 24 of the drive signal output circuit described above. As the modulator 24 for performing the pulse width modulating on the drive waveform signal WCOM, a common pulse width modulation (PWM) circuit is used. The modulator 24 is composed of a well known triangular wave oscillator 32, and a comparator 31 for comparing the triangular wave output from the triangular wave oscillator 32 with the drive waveform signal WCOM. According to the modulator 24, as shown in FIG. 10, the modulated (PWM) signal is set to HIGH when the drive waveform signal WCOM is higher than the triangular wave, and is set to LOW when the drive waveform signal WCOM is lower than the triangular wave. It should be noted that although in the present embodiment a pulse width modulation circuit is used as the modulator, a pulse density modulation (PDM) circuit can also be used.

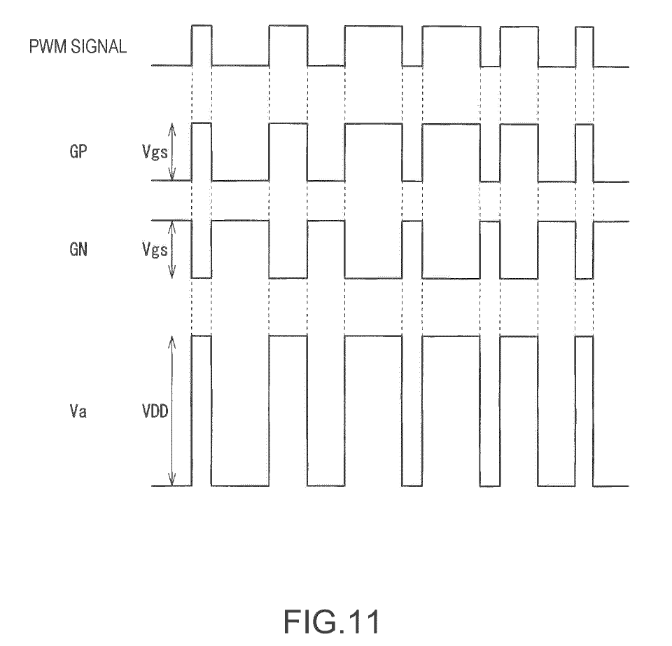

The digital power amplifier 25 is configured including a half-bridge driver stage 33 composed of a MOSFET TrP and TrN for substantially amplifying the power, and a gate drive circuit 34 for controlling the gate-source signals GP and GN of the MOSFET TrP and TrN based on the modulated (PWM) signal from the modulator 24, and the half-bridge driver stage 33 is formed by combining the high-side MOSFET TrP and the low-side MOSFET TrN in a push-pull manner. Assuming that the gate-source signal of the high-side MOSFET TrP is GP, the gate-source signal of the low-side MOSFET TrN is GN, and the output of the half-bridge driver stage 33 is Va, FIG. 11 shows how these signals vary in accordance with the modulated (PWM) signal. It should be noted that the voltage values Vgs of the gate-source signals GP and GN of the respective MOSFET TrP and TrN are assumed to be sufficient to turn on the MOSFET TrP and TrN.

When the modulated (PWM) signal is in the HIGH level, the gate-source signal GP of the high-side MOSFET TrP becomes the HIGH level while the gate-source signal GN of the low-side MOSFET TrN becomes the LOW level, the high-side MOSFET TrP becomes the ON state while the low-side MOSFET TrN becomes the OFF state, and as a result, the output Va of the half-bridge driver state 33 becomes the supply voltage VDD. On the other hand, when the modulated (PWM) signal is in the LOW level, the gate-source signal GP of the high-side MOSFET TrP becomes the LOW level while the gate-source signal GN of the low-side MOSFET TrN becomes the HIGH level, the high-side MOSFET TrP becomes the OFF state while the low-side MOSFET TrN becomes the ON state, and as a result, the output Va of the half-bridge driver state 33 becomes zero.

The output Va of the half-bridge driver stage 33 of the digital power amplifier 25 is supplied to the actuator 22, composed of the piezoelectric element, as the drive signal COM via the selection switch 201 and the low-pass filter 26. The low-pass filter 26 is composed of the combination of a resistor R, an inductance L, and a capacitance C. The low-pass filter 26 is designed to sufficiently attenuate the high frequency component of the output Va of the half-bridge driver stage 33 of the digital power amplifier 25, namely the power amplified modulated (PWM) signal component, and at the same time, not to attenuate the drive signal component COM (or alternatively, the drive waveform component WCOM). Further, the characteristics of the low-pass filter can be set so as to reduce the variation in amount of liquid emitted caused by the individual differences of the nozzles or the actuators 22, if necessary.

As described above, when the MOSFET TrP and TrN of the digital power amplifier 25 are driven in a digital manner, since the MOSFET acts as a switch element, although the current flows in the MOSFET in the ON state, the drain-source resistance is extremely small and the power loss is small. Further, since no current flows in the MOSFET in the OFF state no power loss occurs. Therefore, the power loss of the digital power amplifier 25 is extremely small, a small-sized MOSFET can be used, and a cooling unit, such as a heat radiation plate, can be eliminated. Incidentally, the efficiency when the transistor is driven in the linear range is about 30% while the efficiency of a digital power amplifier is higher than 90%. Further, since the heat radiation plate for cooling the transistor is about 60 mm square in size for each transistor, if such a radiation plate can be eliminated, an overwhelming advantage in the actual layout can be obtained.

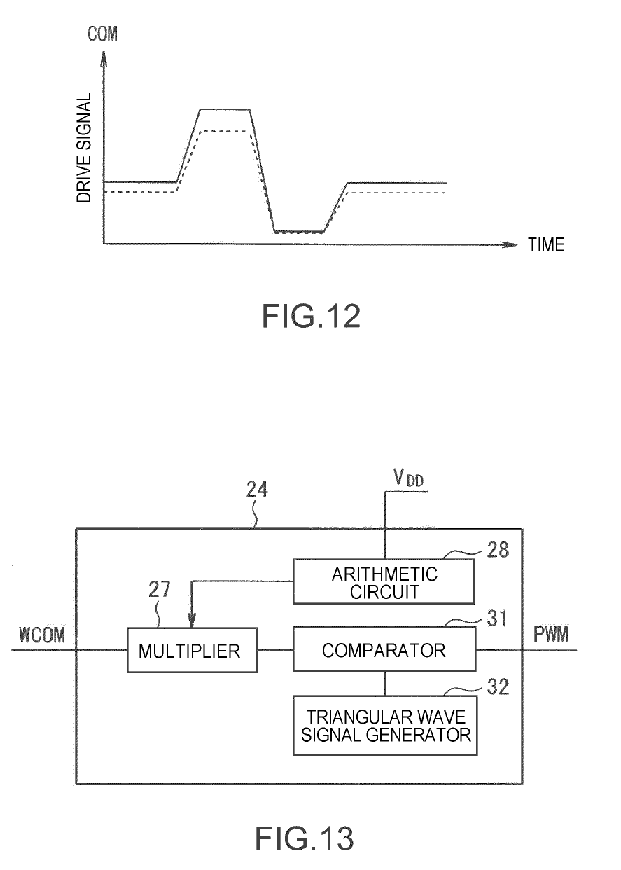

The configuration of the modulator 24 according to the first embodiment will now be described. In the digital power amplifier 25, the voltage value of the drive signal COM changes with the change of the power supply voltage VDD. The voltage in the drive signal COM is indicated as a solid line in FIG. 12 when the power supply voltage VDD is the rated value. The voltage value of the drive signal COM deteriorates with the deterioration of the power supply voltage VDD as indicated by the broken line in FIG. 12. The change of the voltage in the drive signal COM translates into a change of the operation of the actuator 22. Accordingly, the amount of liquid jetted changes and, as a result, a desired print image quality cannot be obtained. Such a change in the power supply voltage VDD cannot be avoided as long as a commercial power supply is used.

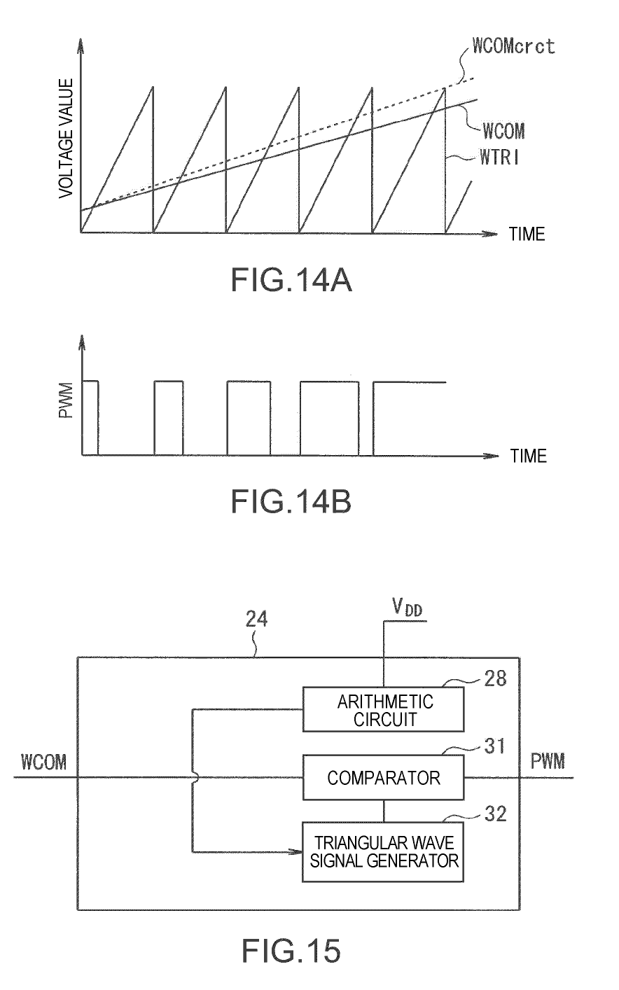

In the first embodiment of the modulator 24, as shown in FIG. 13, a multiplier 27 is provided on the input side of the comparator 31 and an arithmetic circuit 28 configured by a computer system is provided. By this arithmetic circuit 28, the power supply voltage VDD is read to adjust the gain (coefficient) of the multiplier 27. The gain is set as the value VDDstd/VDD where a predetermined power supply voltage VDDstd is divided by the detected power supply voltage VDD. FIG. 14A shows the voltage values of the drive waveform signal WCOM before correction, a corrected drive waveform signal WCOMcrct corrected by multiplying WCOM by the gain VDDstd/VDD and a triangular wave signal WTRI output from the triangular wave signal oscillator 32. FIG. 14B shows the modulation (PWM) signal produced from the corrected drive waveform signal WCOMcrct and the triangular wave signal WTRI. As is clear from the Figures, the modulation signal to generate the original drive signal COM is output by correcting the drive waveform WCOM by an actual power supply voltage VDD. As a result, the voltage value of the drive signal COM can be maintained at a predetermined value to fix the amount of liquid jetted.

According to the first embodiment as described above, the drive waveform signal WCOM controlling the drive of the actuator 22 is generated in the drive waveform generator 70. The drive waveform signal WCOM thus generated is subject to pulse modulation in the modulator 24 and the power of the modulation signal is amplified in the digital power amplifier 25. The power amplified modulated signal is smoothed in the low-pass filter 26 to be supplied as the drive signal COM to the actuator 22. Accordingly, the filter characteristics of the low-pass filter 26 are to be capable of sufficiently smoothing the amplified signal, and thereby high-speed rise and fall of the drive signal COM to the actuator 22 can be achieved. Additionally, since the drive signal COM can be subject to power amplification efficiently by the digital power amplifier 25 with little power loss, a cooling unit, such as cooling radiator plate, is not required. Therefore, a plurality of liquid jet heads can be efficiently arranged and the printing apparatus can be smaller in size.

In addition, since the modulated signal is corrected according to the power supply voltage VDD to the digital power amplifier 25, the change of the voltage in the drive signal COM due to the change of the power supply voltage VDD to the digital power amplifier 25 can be reduced and prevented while reducing and preventing an increase in the number of parts and in the cost. Further, since the power supply voltage VDD to the digital power amplifier 25 is detected to correct the drive waveform signal WCOM generated in the drive waveform generator 70 based on the detected power supply voltage VDD, the change of the voltage in the drive signal COM due to the change of the power supply voltage VDD to the digital power amplifier 25 can be reliably reduced and prevented.

Moreover, the correction of the modulated signal can be achieved digitally, i.e., an arithmetic process from the drive waveform generator 70 to the modulation circuit 24 can be used. Thereby it is advantageous in terms of structure, cost, layout, power consumption, S-data transmission rate, heating value and so on.

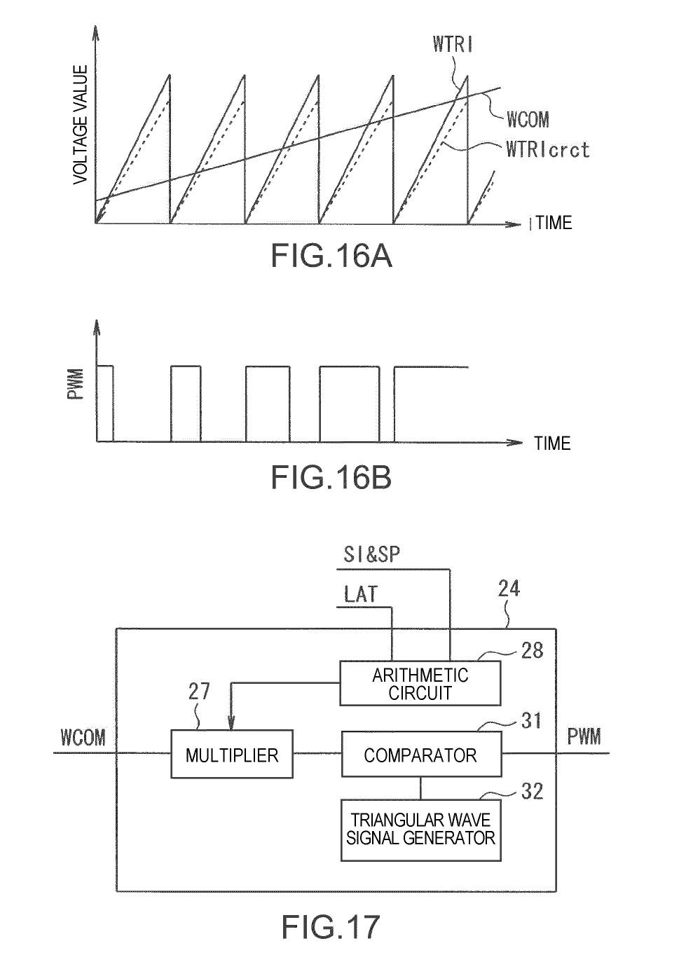

A second embodiment of the invention will now be described. FIG. 15 is a block diagram showing the modulator 24 in the second embodiment. In the second embodiment, the multiplier in the first embodiment is removed and the power supply voltage VDD is read in the arithmetic circuit 28 to adjust the peak voltage value of the triangular wave signal, i.e., oscillation of triangular wave signal WTRI output from the triangular wave signal oscillator 32 is adjusted. Oscillation is calculated by multiplying a predetermined oscillation in design by a correction factor VDD/VDDstd calculated by dividing the detected power supply voltage VDD by a predetermined power supply voltage VDDstd in design. In configuring the triangular wave signal WTRI digitally, the value calculated by multiplying the triangular wave signal WTRI by the correction factor VDD/VDDstd is a corrected triangular wave signal WTRIcrct. FIG. 16A shows the voltage values of the triangular wave signal WTRI before correction, the corrected triangular wave signal WTRIcrct corrected by multiplying the triangular wave signal WTRI by the correction factor VDD/VDDstd, and the drive waveform signal WCOM. FIG. 16B shows the modulation signal (PWM signal) produced from the drive waveform signal WCOM and the corrected triangular wave signal WTRIcrct. As is clear from the Figures, the modulation signal to generate the original drive signal COM is output by correcting the oscillation of the triangular wave signal WTRI by an actual power supply voltage VDD. As a result, the voltage in the drive signal COM can be maintained at a predetermined value to fix the amount of liquid jetted.

According to the second embodiment as described above, in addition to the advantages obtained in the first embodiment, since the power supply voltage VDD to the digital power amplifier 25 is detected to correct the oscillation of the triangular wave signal WTRI for pulse modulation based on the detected power supply voltage VDD, the change of the voltage in the drive signal COM due to the change of the power supply voltage VDD to the digital power amplifier 25 can be reliably reduced and prevented.

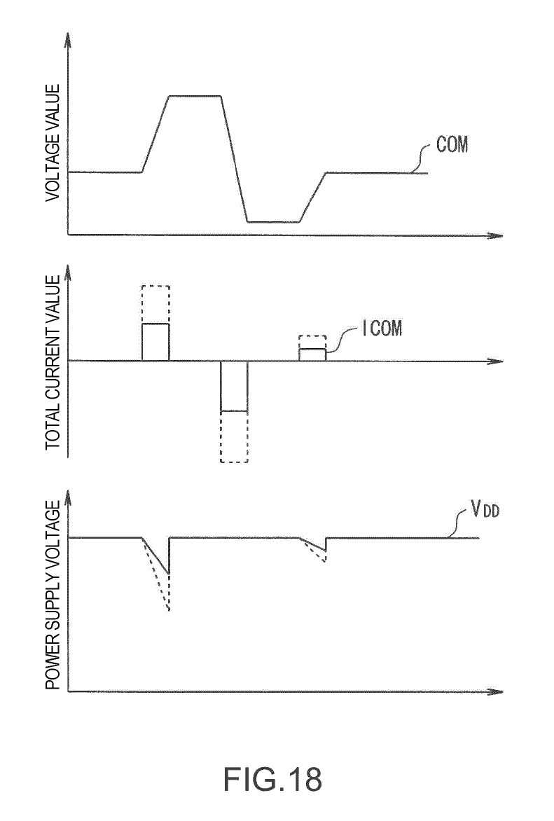

A third embodiment of the invention will now be described. FIG. 17 is a block diagram showing the modulator 24 in the third embodiment. The configuration of the modulator 24 in the third embodiment is similar to the first embodiment as shown in FIG. 13. However, in the arithmetic circuit 28, the drive pulse selection data SI & SP and the latch signal LAT are input to adjust the gain of the multiplier 27. FIG. 18 shows the change of the total current value ICOM and the power supply voltage VDD of the drive signal COM according to the number of nozzles to be driven, i.e., the number of actuators to be driven. The total current value consumed in all driving actuators increases with an increase in the number of actuators to be driven. The power supply voltage VDD deteriorates, even if temporarily, with the increase of the total current value. The deterioration of the power supply voltage VDD generated by the driving actuators cannot be corrected by detecting the power supply voltage VDD to correct the modulation signal as in the first and second embodiments as described above.

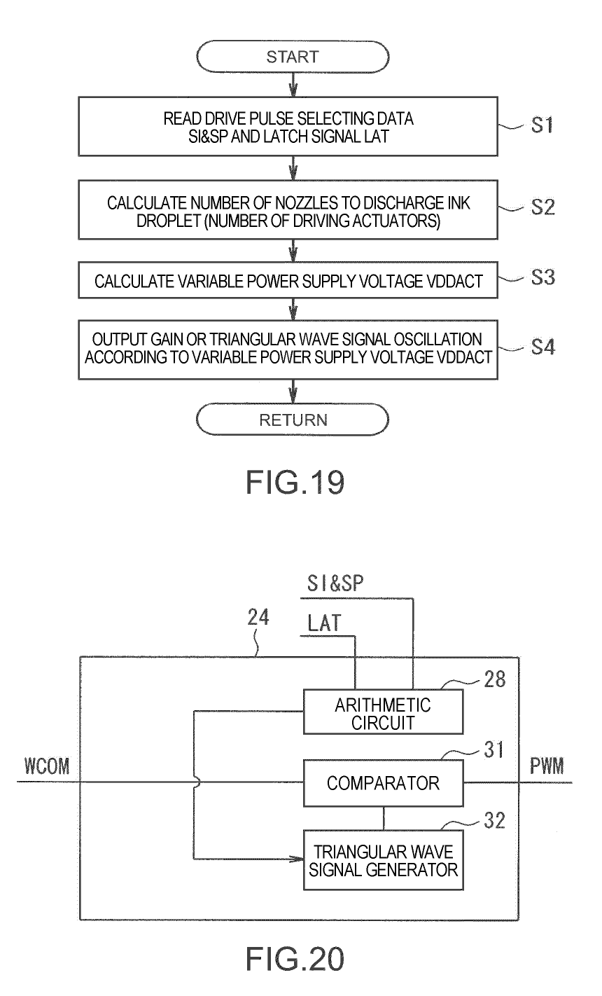

Therefore in the third embodiment, an arithmetic process shown in FIG. 19 is performed in the arithmetic circuit 28 to calculate a variable power supply voltage VDDACT and to correct the modulation signal by using this variable power supply voltage VDDACT. In this arithmetic process, the drive pulse selection data SI & SP and the latch signal LAT are first read in step S1.

Next in step S2 the number of actuators to be driven is calculated according to the drive pulse selection data SI & SP and the latch signal LAT read in step S1.

Next in step S3 the variable power supply voltage VDDACT is calculated according to the number of actuators to be driven which was calculated in step S2.

Next in step S4 the gain is output to the multiplier 27 according to the variable power supply voltage VDDACT calculated in step S3 and then the process returns to the main program. It should be noted that the method of setting the gain is the same as in the first embodiment as described above.

According to this arithmetic process, the number of actuators to be driven is calculated according to the drive pulse selection data SI & SP and the latch signal LAT, the variable power supply voltage VDDACT is calculated according to the calculated number of actuators, and the drive waveform signal WCOM, and therefore, the modulation signal, is corrected by outputting the gain to the multiplier 27 according to the calculated variable power supply voltage VDDACT. Therefore, the voltage in the drive signal COM can be maintained at a predetermined value to fix the amount of liquid jetted by considering the power supply voltage VDD and the number of actuators to be driven.

According to the third embodiment as described above, in addition to the advantages obtained in the first and second embodiments, since the variable power supply voltage VDDACT to the digital power amplifier 25 is calculated based on the number of actuators 22 to be driven in order to correct the drive waveform signal WCOM generated in the drive waveform generator 70, the change of the voltage in the drive signal COM due to the rapid change of the power supply voltage VDD to the digital power amplifier 25 can be reliably reduced and prevented.

A fourth embodiment of the invention will now be described. FIG. 20 is a block diagram showing the modulator 24 in the fourth embodiment. The configuration of the modulator 24 in the fourth embodiment is similar to the second embodiment as shown in FIG. 15. However, in the arithmetic circuit 28, the drive pulse selection data SI & SP and the latch signal LAT are input to adjust the oscillation of the triangular wave signal WTRI. More specifically, the triangular wave signal oscillation according to the variable power supply voltage VDDACT is output in step S4 of the arithmetic process in FIG. 19 of the third embodiment as described above. The method of calculating the triangular wave signal oscillation is the same as in the second embodiment.

According to this arithmetic process, the number of actuators to be driven is calculated according to the drive pulse selection data SI & SP and the latch signal LAT, the variable power supply voltage VDDACT is calculated according to the calculated number of actuators, and the modulation signal is corrected by outputting the triangular wave signal according to the calculated variable power supply voltage VDDACT to the triangular wave signal oscillator 32. Therefore, the voltage value of the drive signal COM can be maintained at a predetermined value to fix the amount of liquid jetted.

According to the fourth embodiment as described above, in addition to the advantages obtained in the first through third embodiments, since the variable power supply voltage VDDACT to the digital power amplifier 25 is calculated according to the number of actuators 22 to be driven to correct the oscillation of the triangular wave signal WTRI for pulse modulation based on the calculated variable power supply voltage VDDACT, the change of the voltage in the drive signal COM due to the rapid change of the power supply voltage VDD to the digital power amplifier 25 can be reliably reduced and prevented.

It should be noted that although in the present embodiment, only the application of the present invention to the line head printing apparatus is explained in detail, the liquid jet apparatus and the printing apparatus according to the present invention can also be applied to a multi-pass printing apparatus or any other type of printing apparatus for printing letters or images on a print medium by emitting liquid jet as a target thereof. Further, each section configuring the liquid jet apparatus or the printing apparatus of the present invention can be replaced with an arbitrary configuration capable of exerting a similar function, or added with an arbitrary configuration.

Further, as a liquid emitted from the liquid jet apparatus of the present invention, there is no particular limitation, and liquids (including dispersion liquids, such as suspensions or emulsions) containing various kinds of materials as mentioned below are cited, for example. Specifically, ink containing a filter material of a color filter, a light emitting material for forming an EL light emitting layer in an organic electroluminescence (EL) device, a fluorescent material for forming a fluorescent substance on an electrode in a field emission device, a fluorescent material for forming a fluorescent substance in a plasma display panel (PDP) device, electrophoretic material for forming an electrophoretic substance in an electrophoretic display device, a bank material for forming a bank on a substrate W, various coating materials, a liquid electrode material for forming an electrode, a particle material for forming a spacer for forming a microscopic cell gap between two substrates, a liquid metal material for forming metal wiring, a lens material for forming a microlens, a resist material, a light diffusion material for forming a light diffusion material, and so on can be cited.

Further, in the present invention, the print medium to be a target of the liquid jet emission is not limited to a piece of paper, such as a recording sheet, but can be a film, a cloth, a nonwoven cloth, or other medium, or works, such as various substrates such as a glass substrate, or a silicon substrate.

What is claimed is:

1. A liquid jet apparatus comprising:
a plurality of nozzles;
an actuator provided for each nozzle and connected to the respective nozzle; and
a drive unit for applying a drive signal to the actuator, wherein the drive unit includes:
a drive waveform generator for generating a drive waveform signal for controlling the drive of the actuator;
a modulator for performing a pulse modulation of the drive waveform signal to produce a modulated signal;
a digital power amplifier for power amplifying the modulated signal to produce an amplified signal;
a low-pass filter for smoothing the amplified signal and supplying the drive signal to the actuator; and
a modulation signal correcting unit that corrects the modulated signal according to a power supply voltage of the digital power amplifier.

2. The liquid jet apparatus according to claim 1, wherein the modulation signal correcting unit comprises:
a power supply voltage detecting unit that detects the power supply voltage of the digital power amplifier; and
a triangular wave signal correcting unit that corrects an oscillation of a triangular wave signal used for the pulse modulation, based on the power supply voltage detected by the power supply voltage detecting unit.

3. A printing apparatus comprising:
a feeding unit that feeds a print medium to the printing apparatus;
a plurality of nozzles;
an actuator provided for each nozzle and connected to the respective nozzle; and
a drive unit for applying a drive signal to the actuator, wherein the drive unit includes:
a drive waveform generator for generating a drive waveform signal for controlling the drive of the actuator;
a modulator for performing a pulse modulation of the drive waveform signal to produce a modulated signal;
a digital power amplifier for power amplifying the modulated signal to produce an amplified signal;
a low-pass filter for smoothing the amplified signal and supplying the drive signal to the actuator; and
a modulation signal correcting unit that corrects the modulated signal according to a power supply voltage of the digital power amplifier.

4. The printing apparatus according to claim 3, wherein the modulation signal correcting unit comprises:
a power supply voltage detecting unit that detects the power supply voltage of the digital power amplifier; and
a triangular wave signal correcting unit that corrects an oscillation of a triangular wave signal used for the pulse modulation, based on the power supply voltage detected by the power supply voltage detecting unit.
